(19) United States
(12) Patent Application Publication
(10) Pub. No.: US 2006/0265877 A1
(43) Pub. Date: Nov. 30, 2006

(54) Removal of a paint roller cover by application of impulsive force

(76) Inventor: Dana P. Cumings, Los Gatos, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/129,091

(22) Filed: May 13, 2005

(51) Int. Cl. B23P 19/00

(52) U.S. Cl. 29/895.1; 29/426.5; 29/724

(57) ABSTRACT

Improved apparatus and method for removing a paint roller cover from a paint roller frame is provided. In one embodiment, a gripper is engaged with a paint roller cover which is on a paint roller frame. The gripper includes a guide along which a body is freely movable. The guide directs the motion of the body such that the body can strike a surface of the frame without touching the cover. In operation, a user can employ the body as a hand tool to strike only the frame and thereby separate the cover from the frame. Accuracy of the blow is ensured by the guide. In another embodiment, a member of the gripper extends past the frame. Striking this member (e.g., against a wall) can separate the cover from the frame, since an impulsive force tending to separate cover from frame is thereby generated.

### FIELD OF THE INVENTION

The present invention relates to paint rollers and especially to removing a paint roller cover from a paint roller frame.

### BACKGROUND

Paint rollers are commonly employed devices for painting. FIG. 1 shows a typical paint roller having a cylindrical paint roller cover 102, a paint roller frame end 104, and a handle 106. Only part of handle 106 is shown on FIG. 1. The frame rotates about an axis defined by handle 106 as the paint roller is moved across a surface being painted. As this motion occurs, paint is transferred from cover 102 to the surface being painted. Cover 102 is typically removable from the frame (e.g., by sliding it to the left on FIG. 1). Such removability can facilitate cleaning and/or replacement of cover 102.

Significant practical problems in providing removable paint roller covers are known. For example, paint tends to accumulate between the paint roller frame and paint roller cover 102. Once this accumulated paint dries, it can act as an adhesive and make it difficult to remove the cover from the frame. Various approaches for overcoming this problem have been considered in the art.

U.S. Pat. No. 4,667,361 considers a tool which can function to scrape paint from a paint roller cover and/or to act as a gripper attachable to the paint roller cover for removing it from the frame. U.S. Pat. No. 2,961,683 considers a pair of tongs suitable for grasping a paint roller cover for removal from the paint roller frame. Another gripper device is considered in U.S. Pat. No. 6,829,803. U.S. Pat. No. 5,832,557 considers a tool adapted for engaging with an end of a paint roller cover to facilitate pushing the cover off the frame. These approaches provide a way to securely grip or push a paint roller cover, which can be slippery if it is wet with paint. However, the problem of applying sufficient force to remove the paint roller cover from the frame is not addressed by these approaches.

U.S. Pat. No. 4,985,974, U.S. Pat. No. 4,584,752 and U.S. Pat. No. 5,283,923 consider a device that includes a gripper attachable to the paint roller cover and a piston engagable with the paint roller frame and hand-driven by a ratchet mechanism to remove the cover from the frame. U.S. Pat. No. 6,405,404 considers a special paint roller frame having a mechanism for disengaging the frame from the cover to facilitate removal of the cover. These approaches rely on mechanisms (e.g., the ratchet mechanism, or the special frame) which may not perform as desired in actual use. For example, a ratchet mechanism (or a special frame) may not work once it becomes clogged with paint.

A simpler mechanism is considered in US 2002/0138935, where the frame is engaged with the cover for only a small fraction of the length of the cover. This reduced engagement, as opposed to the conventional engagement of frame with cover over nearly the entire length of the cover, can facilitate removal of the cover from the frame. For example, a single rap may suffice to remove the cover from the frame. Although this approach is relatively simple, it is not apparent that it will address cases where the cover is stuck to the frame with dried paint. Also, this reduced engagement of cover with frame may cause other problems (e.g., an unstable connection between paint roller cover and paint roller frame during painting).

Accordingly, it would be an advance in the art to provide effective removal of a paint roller cover with a simple and practical mechanism.

### SUMMARY

The present invention provides improved apparatus and methods for removing a paint roller cover from a paint roller frame. A key idea of the present invention is to provide an impulsive force tending to separate the cover from the frame. Impulsive forces are particularly suitable for breaking an adhesive bond between cover and frame that may be present due to dried paint. In one embodiment, a gripper is engaged with a paint roller cover which is on a paint roller frame. The gripper includes a guide along which a body is freely movable. The guide directs the motion of the body such that the body can strike a surface of the frame without touching the cover. In operation, a user can employ the body as a hand tool to strike only the frame and thereby separate the cover from the frame. Accuracy of the blow is ensured by the guide. In another embodiment, a member of the gripper extends past the frame. Striking this member (e.g., against a wall) can separate the cover from the frame, since an impulsive force tending to separate cover from frame is thereby generated.

The present invention advantageously provides a simpler way to remove a paint roller cover from a paint roller frame than the prior art methods described above. Such simplicity is especially important in practice, since the simpler a mechanism is, the more likely it is to continue functioning as desired in practice. In other words, an apparatus intended for use in painting is preferably simple enough mechanically to tolerate some amount of accumulated paint.

### BRIEF DESCRIPTION OF THE DRAWINGS

FIG. 1 shows a paint roller including a cover and a frame.

FIG. 2 shows a cut-away view of an embodiment of the invention.

FIG. 3 shows an end view of another embodiment of the invention.

FIG. 4 shows another end view of the embodiment of FIG. 3.

FIGS. 5a-b show top views of paint roller cover grippers suitable for use with embodiments of the invention.

FIG. 6 shows an alternate embodiment of the invention.

FIG. 7 shows another alternate embodiment of the invention.

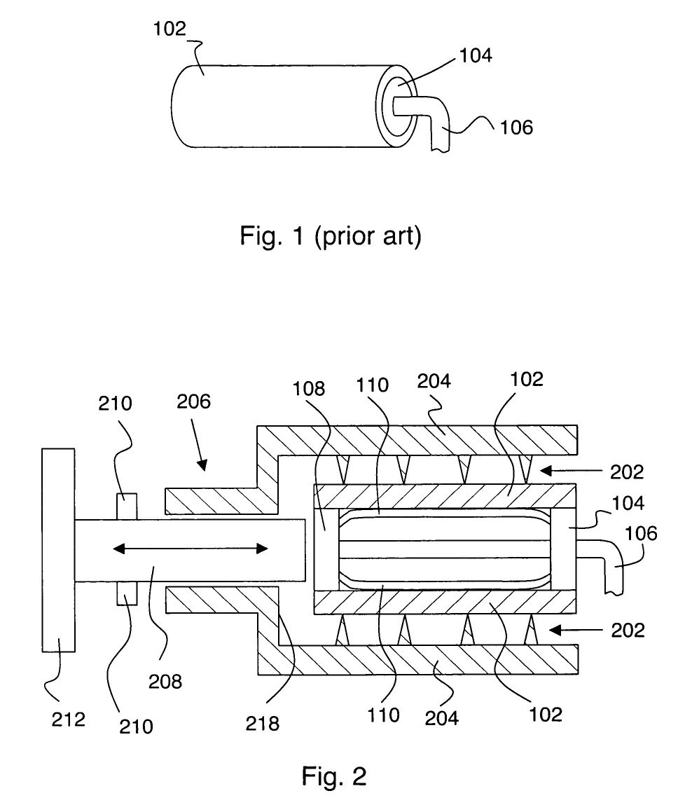

### DETAILED DESCRIPTION

FIG. 2 shows a cut-away view of an embodiment of the invention. A paint roller cover 102 is engaged with a paint roller frame. The paint roller frame includes an end 104, another end 108, and spring members 110 which extend from end 104 to end 108 and make contact with paint roller cover 102. The paint roller frame is preferably a conventional paint roller frame having spring members 110 which engage with paint roller cover 102 along nearly the entire length of cover 102, as shown. Ends 104 and 108 are attached to and rotatable about a handle 106.

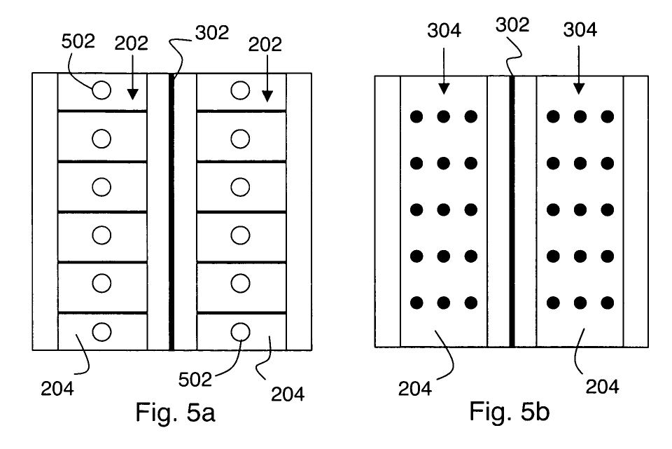

A gripper 204 is shown engaged with an outer cylindrical surface of paint roller 102. To facilitate this engagement, the gripper preferably includes engagement features 202 suitable for making secure, non-sliding contact with paint roller cover 102. Engagement features 202 as shown on FIG. 2 are generally ridge-like and circumferential about the outer cylindrical surface of paint roller 102, which is a preferred configuration. Further details and alternatives relating to gripper engagement features is given below in connection with FIGS. 5a-b. Preferably gripper 204 includes a flat outward facing surface, for mounting or other purposes.

The embodiment of FIG. 2 also includes a body 208 and a guide 206. Guide 206 is affixed to gripper 204. Body 208 is freely movable along a path determined by guide 206, as shown by the double headed arrow on FIG. 2. Guide 206 preferably includes a tube surrounding body 208, although any other functionally equivalent arrangement (e.g., slots engaged with parts of body 208) could also be employed for guide 206. Body 208 can be moved to a contact position where it makes contact with the paint roller frame, but not with paint roller cover 102. More specifically, body 208 can make contact with end 108 of the paint roller frame. Preferably, end 108 of the paint roller frame and a part of body 208 both have substantially circular cross sections, the part of body 208 having a smaller diameter than end 108. This configuration ensures that body 208 does not make contact with paint roller cover 102 in the preferred situation where body 208 and the paint roller frame are aligned to the same axis (as shown).

In operation, a user can forcefully impel body 208 to strike end 108 of the paint roller frame. Because guide 206 directs body 208 toward end 108 and away from paint roller cover 102, the user is not required to exercise special care to aim the blow struck by body 208. The sharp impulsive force thus delivered accurately to the paint roller frame is particularly suitable for removing paint roller cover 102 from the paint roller frame, especially in cases where dried paint is acting as an adhesive between the cover and the frame. Thus a key idea of this embodiment of the invention is to enable a user to accurately deliver an impulsive force to the paint roller frame with a body acting as a hammer.

Body 208 is preferably operated as a hand tool, in sharp contrast to certain complicated prior art mechanisms. Thus body 208 can be any object suitable for performing the basically “hammer-like” function described above. Another key feature of the present invention is that body 208 is freely movable along the path defined by guide 206. This freedom of motion contrasts sharply with prior art mechanisms having a ratchet-driven piston which is not freely movable.

Preferred embodiments may include one or more optional features. One optional feature is a handle 212, to provide a hand grip on body 208 for a user of the invention. Another optional feature is a finger guard 210, disposed to prevent a user's fingers from being caught between guide 206 and body 208. In the example of FIG. 2, fingers disposed between handle 212 and guard 210 (i.e., gripping handle 212) are thus protected. Another optional feature is a retaining ring (or member), to prevent body 208 from being moved to a position completely outside guide 206. Such an embodiment advantageously eliminates the possibility of body 208 being lost as a result of being separated from the rest of the apparatus. Preferably, such a retaining member allows body 208 to be moved to a position which is almost completely disengaged from guide 206. It is also preferable for the retaining member to include features (e.g., sloped surfaces) that prevent the retaining member from “catching” on the part of guide 206 closest to the paint roller frame. Another preferred feature is for guide 206 to telescope to a position inside gripper 204 when not in use, to allow for more compact storage.

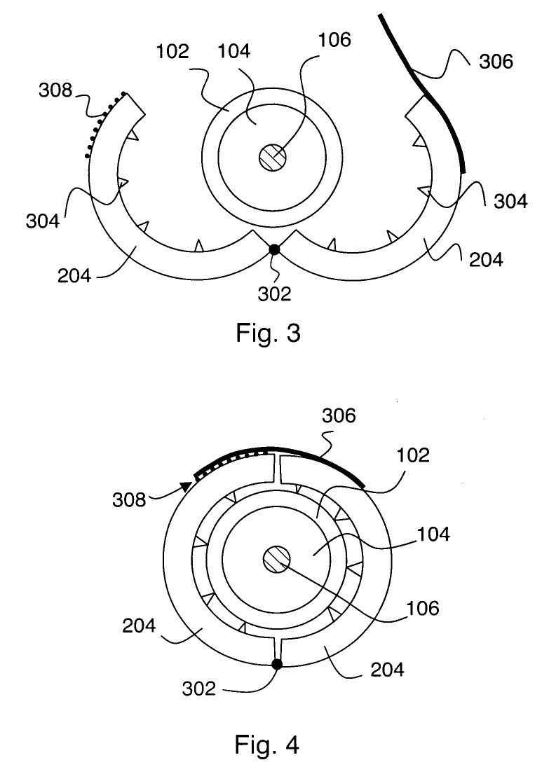

FIG. 3 shows an end view of another embodiment of the invention. In this embodiment, gripper 204 is shown as including a pair of hemi-cylindrical sections attached to each other at a hinge 302. Gripper 204 of the embodiment of FIG. 3 includes engagement features 304. In this example, engagement features 304 are discrete spikes or pins as opposed to ridges 202 as shown on FIG. 2. Gripper 204 is preferably designed such that it can easily be engaged or disengaged with the outer cylindrical surface of paint roller cover 102. As indicated above, many methods for performing this function are known in the art, and any of these methods can be used with the present invention. Suitable engagement features for gripper 204 include screws, ridges, pins and spikes. These engagement features can be fixed, spring-loaded and/or adjustable. Further details relating to gripper engagement feature configurations are shown on FIGS. 5a-b.

The embodiment of FIG. 3 preferably includes one or more fasteners to hold the hemi-cylindrical sections of gripper 204 together to engage with the paint roller cover. Suitable fasteners include clamps, buckles and hook tape. Here hook tape refers to an arrangement where one surface has many small fibrous loops and another surface has many small hooks which can engage with the loops to fasten the surfaces together in a removable manner. Hook tape is sometimes known in trade as Velcro®. On FIG. 3, facing surfaces of strap 306 and area 308 have a hook tape arrangement. FIG. 4 shows the embodiment of FIG. 3 when gripper 204 is engaged with paint roller cover 102. In other embodiments of the invention, the fasteners are preferably simple mechanical buckles instead of hook tape, since paint may accumulate in a hook tape fastener and be difficult to remove.

FIGS. 5a-b show top views of paint roller cover grippers suitable for use with embodiments of the invention. FIG. 5a shows a top view of an engagement feature configuration consistent with the embodiment of FIG. 2 (i.e., ridges). Ridges 202 are preferably perpendicular to the forces which are required to remove the paint roller cover from the paint roller frame (as shown). This perpendicularity reduces the likelihood the paint roller cover will slip relative to the gripper when the paint roller frame is struck. In the embodiment of FIG. 5a, it is preferred for drainage holes 502 to be disposed between ridges 202. The reason to provide drainage holes 502 is to facilitate removal of paint that may accumulate between ridges 202.

FIG. 5b shows a top view of an engagement feature configuration consistent with FIGS. 3 and 4 (i.e., spikes). Spikes 304 are arranged as a cylindrically inward-facing “bed of nails” suitable for engaging paint roller cover 102. Drainage holes as on FIG. 5a can also be included in this embodiment, although accumulation of paint between spikes is expected to be less troublesome than paint accumulation between ridges.

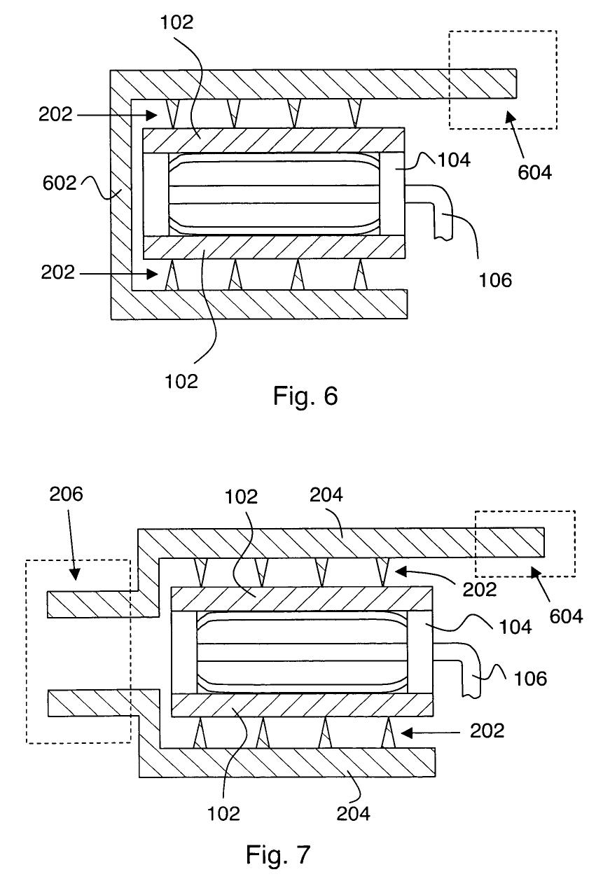

FIG. 6 shows an alternate embodiment of the invention. In this embodiment, a gripper 602 has engagement features 202 (e.g., ridges) engaged with paint roller cover 102 as in FIG. 2. Gripper 602 includes a member 604 which extends past an end surface of the paint roller frame. More specifically, member 604 extends past end 104 of the paint roller frame, and preferably also extends past handle 106, as shown. In operation, a surface of member 604 is struck in order to remove paint roller cover 102 from the paint roller frame. As in the previous embodiments, delivery of an impulsive force tending to separate the paint roller cover from the paint roller frame is a key aspect of the invention. The reason member 604 extends past the paint roller frame is to facilitate striking member 604 without striking the paint roller frame. For example, the entire assembly of FIG. 6 can be directed (e.g., moved to the right on FIG. 6) toward a fixed object, such as a wall, such that only member 604 strikes the fixed object.

FIG. 7 shows another alternate embodiment of the invention. In this embodiment, gripper 204 includes a member 604 as on FIG. 6, and includes a guide 206 as on FIG. 2. This versatile embodiment can be operated either as indicated in connection with FIG. 2 or as indicated in connection with FIG. 6 to remove paint roller cover 102 from the paint roller frame.

The invention can be practiced according to many modifications of the preceding embodiments, and generally does not rely on the use of particular materials or on the use of particular detailed designs. For example, the gripper, guide and/or body can be fabricated from any suitable tool materials, such as metals, plastics, composite materials and the like.

1. Apparatus for removing a paint roller cover from a paint roller frame, the apparatus comprising:
a) a gripper engagable with an outer cylindrical surface of the paint roller cover;
b) a guide affixed to the gripper;
c) a body freely movable along a path determined by the guide to a contact position;
wherein the body in the contact position makes contact with an end surface of the paint roller frame and does not make contact with the paint roller cover.

2. The apparatus of claim 1, wherein said gripper includes fixed, spring-loaded or adjustable engagement features selected from the group consisting of screws, ridges, and pins.

3. The apparatus of claim 2, wherein said engagement features comprise ridges, and wherein said gripper further includes holes disposed between the ridges.

4. The apparatus of claim 1, wherein said gripper is substantially cylindrical about an axis and comprises two hemi-cylindrical sections attached to each other at a hinge.

5. The apparatus of claim 4, wherein said hemi-cylindrical sections are held together to engage said paint roller cover by a fastener selected from the group consisting of hook tape, clamps, and buckles.

6. The apparatus of claim 1, wherein said body includes a handle for manual operation.

7. The apparatus of claim 6, wherein said body includes a guard disposed to prevent contact between a hand of an operator and said gripper when the hand is holding said handle.

8. The apparatus of claim 1, wherein part of said body is substantially cylindrical and wherein a surface of the part of said body that makes contact with said paint roller frame has a diameter less than a diameter of said paint roller frame.

9. The apparatus of claim 1, wherein said guide includes a tube fitting around said body.

10. The apparatus of claim 1, wherein said body further comprises a retaining member disposed to prevent complete removal of said body from said guide.

11. A method for removing a paint roller cover from a paint roller frame, the method comprising:
a) gripping an outer cylindrical surface of the paint roller cover with a gripper;
b) providing a guide affixed to the gripper;
c) freely moving a body along a path determined by the guide to a contact position;
wherein the body in the contact position makes contact with an end surface of the paint roller frame and does not make contact with the paint roller cover.

12. The method of claim 11, wherein said freely moving comprises delivering a sharp impact to said paint roller frame with said body, whereby removal of said cover from said frame is effected.

13. A method for removing a paint roller cover from a paint roller frame, the method comprising:
a) gripping an outer cylindrical surface of the paint roller cover with a gripper, wherein the gripper includes a member extending past an end surface of the paint roller frame;
b) striking a surface of the member to remove the cover from the frame.
